(19) United States
(12) Patent Application Publication
(10) Pub. No.: US 2014/0236892 A1
(43) Pub. Date: Aug. 21, 2014

(54) SYSTEMS AND METHODS FOR VIRTUAL MACHINE BACKUP PROCESS BY EXAMINING FILE SYSTEM JOURNAL RECORDS

(71) Applicant: Barracuda Networks, Inc., Campbell, CA (US)

(72) Inventor: Andy Blyler, Ann Arbor, MI (US)

(73) Assignee: Barracuda Networks, Inc., Campbell, CA (US)

(21) Appl. No.: 14/186,969

(22) Filed: Feb. 21, 2014

Related U.S. Application Data
(60) Provisional application No. 61/767,781, filed on Feb. 21, 2013.

(51) Int. Cl. G06F 17/30

(52) U.S. Cl. CPC G06F 17/30191; G06F 17/30174; G06F 17/30233
USPC 707/625

(57) ABSTRACT

A new approach is proposed that contemplates systems and methods to support backing up only portions of data associated with a virtual machine that have been changed since the last backup of the data was performed. During a backup process, the proposed approach looks for a journal record of a file system located within one of the partitions on a virtual disk of the virtual machine, wherein the journal record reflects disk operations that have been performed to a storage device associated with a host device/machine running the virtual machine. Once portions of the storage device which data have been modified since the last data backup are identified based on the journal of the file system, only the modified portions of the storage device are submitted to the backup process to be backed up to a backup storage device.

### CROSS-REFERENCE TO RELATED APPLICATIONS

This application claims the benefit of U.S. Provisional Patent Application No. 61/767,781, filed Feb. 21, 2013, and entitled “Virtual Machine Backup Process by Examining File System Journal Records,” and is hereby incorporated herein by reference.

### BACKGROUND OF THE INVENTION

In information technology, a backup process refers to the copying and archiving of data currently stored on a first storage device such as one or more hard disk drives associated with one computing device to a second (remote) storage device at a location different from the first storage device. The backed up data can be used to recover the data on the first storage device in the event of data loss or to restore data on the first storage device to an earlier point in time.

A virtual machine (VM) is a software implementation of a physical machine (i.e. a computer) that executes programs to emulate an existing computing environment such as an operating system (OS). The VM runs on top of a hypervisor, which creates and runs one or more virtual machines on a physical machine or host. The hypervisor presents each VM with a virtual operating platform and manages the execution of each VM on the host machine. By enabling multiple VMs having different operating systems to share the same host machine, the hypervisor leads to more efficient use of computing resources, both in terms of energy consumption and cost effectiveness, especially in a cloud computing environment.

With the explosive growth in the quantity of digital data in various forms, such as emails, faxes, application data, documents, and media files, backing up an entire VM (including the operating system installation, application files and settings, user data) as well as data associated with or accessed by the VM is very time consuming process and prohibitively costly with a high potential of backing up a lot of redundant data that have been unchanged since the last backup. As a result, incremental backup of only the data that have been modified since the last backup was performed without duplicating storage is often used for frequent backup of data associated with the VM. However, utilizing features provided by a VM for tracking changes blocks tracking can be time and computing resource consuming. In addition, not all VMs provide native support for changed block tracking. It is thus desirable to be able to efficiently identify data blocks on the storage device that have been modified by the VM for incremental backup of data without relying on features provided by the VM.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows an example of a system diagram to support backup of virtual machine data via file system journal examination.

FIG. 2 depicts a flowchart of an example of a process to support backup of virtual machine data via file system journal examination.

### DETAILED DESCRIPTION OF THE INVENTION

The following disclosure provides many different embodiments, or examples, for implementing different features of the subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support a backup process that backs up only portions of data associated with a virtual machine that have been changed since the last backup of the data was performed. During the backup process, the proposed approach looks for a journal record of a file system located within one of the partitions of a virtual disk of the virtual machine, wherein the journal record reflects disk operations that have been performed to a storage device associated with a hosting server running the virtual machine. Once portions of the storage device which data have been modified since the last data backup are identified based on records of the journal of the file system, only the modified portions of the storage device are submitted to the backup process to be backed up to a (remote) backup storage device.

Since many file systems located within a partition of a virtual disk of a virtual machine inherently create and maintain a journal of records of all disk operations performed by the virtual machine, utilizing such journal for the purpose of identifying modified data blocks or portions on the storage device does not require running any additional process for the purpose of tracking of changed data blocks. Such vendor-neutral approach to changed data block identification is applicable to any virtual machine with or without native support for changed block tracking, and it saves time and computing resources on the hosting server of the virtual machines.

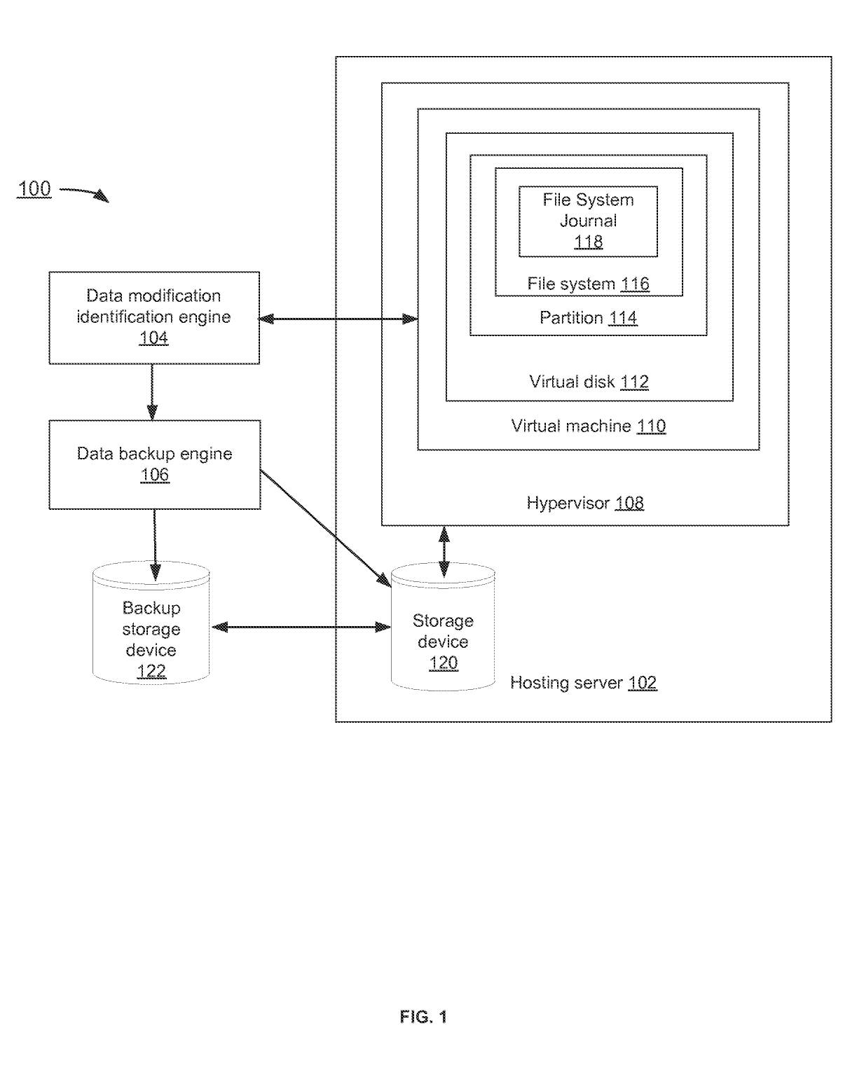

FIG. 1 shows an example of a system diagram to support backup of virtual machine data via file system journal examination. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least data modification identification engine 104 and data backup engine 106. As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the data modification identification engine 104 and the data backup engine 106 can run on at least one host device or host (not shown). Here, host device can be a computing device, a communication device, a storage device, or any electronic device capable of running a software component. For non-limiting examples, a computing device can be but is not limited to a laptop PC, a desktop PC, an iPod, an iPhone, an iPad, a Google's Android device, or a server machine. A storage device can be but is not limited to a hard disk drive, a flash memory drive, or any portable storage device. A communication device can be but is not limited to a mobile phone.

In the example of FIG. 1, each of the data modification identification engine 104 and the data backup engine 106 has a communication interface (not shown), which is a software component that enables the engines to communicate with each other and the hosting server 102 over a network (not shown) following certain communication protocols, such as TCP/IP protocol. Here, the network can be a communication network based on certain communication protocols, such as TCP/IP protocol. Such network can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

In the example of FIG. 1, a hypervisor 108 runs on a hosting server 102, wherein the hypervisor 108 controls processor, storage, as well as other computing resources of the hosting server 102. The hypervisor 108 provides a virtual operating platform that supports and manages one or more virtual machines 110 running on top of the hypervisor 108.

In the example of FIG. 1, a physical storage device 120 of the hosting server 102 includes a disk controller (not shown) coupled to an array of computer readable physical storage components, such as hard disks. It is well known to one ordinarily skilled in the art that each disk of the storage device 120 may include multiple partitions and each partition includes a plurality of blocks for data storage.

In the example of FIG. 1, each virtual machine 110 running on top of the hypervisor 108 includes a virtual disk or vdisk 112, which is a virtual logical disk or volume with which the virtual machine 110 performs I/O operations to the physical storage device 120. The disk is classified as virtual due to the way it maps to the physical storage device 120 which the virtual disk 112 represents. In some embodiments, the virtual disk 112 include a meta-data mapping table between the virtual disk 112 and the storage device 120, wherein the mapping table translates an incoming (virtual) disk identifier and a logical block addressing (LBA) on the virtual disk 112 to a corresponding physical disk identifier and LBA on the storage device 120. In some embodiments, the virtual disk 112 may include logical blocks across multiple physical disks in the storage device 120.

In some embodiments, each virtual disk 112 may further include one or more partitions 114 as shown in FIG. 1, wherein each partition 114 is a logical storage unit of the virtual disk 112 (and the corresponding physical storage device 120) so that different file systems 116 can be used within different partitions of the virtual disk 112. Here, a file system 116 organizes and controls how data is stored and retrieved within a partition 114 of the virtual disk 112. For non-limiting examples, the file system can be but is not limited to one of a New Technology File System (NTFS), a File Allocation Table (FAT), and a High Performance File System (HPFS).

In some embodiments, each file system 116 within a partition 114 may further include a file system journal 118, which records changes in the file system as applications running on the virtual machine 110 perform data I/O operations to the virtual disk 112 and consequently to the disks in storage device 120. As files, directories, and other file system objects are added, deleted, and modified in the file system 116 by the virtual machine 110, the file system 116 enters the changes as records/entries in the file system journal 118 in streams. In some embodiments, each of the records in the file system journal 118 may include one or more of disk I/O operations performed by the virtual machine 110 to data within the file system 116, types of the operations being performed on the data (e.g., write, truncation, lengthening, or deletion operations), and the (logical as well as physical) locations of the data objects and storage blocks which data has been modified by the operations. In some embodiments, the file system journal 118 may also include timestamps of the operations performed. For a series of file operations performed on a file in the file system 116, a series of records between the first opening and last closing of the file are recorded in the file system journal 118. Each record has a new flag set, indicating that a new kind of change has occurred to the file. The sequence of records gives a partial history of changes made to the file.

In the example of FIG. 1, the data modification identification engine 104 is configured to have access to the file system journal 118 of each file system 116 within a virtual machine 110 running on the hypervisor 108 of the hosting server 102 via an Application Programming Interface (API) provided by the hypervisor 108. The data modification identification engine 104 first scans the virtual disk 112 of the virtual machine 110 to identify locations and/or layout of one or more partitions 114 within the virtual disk 112. For each located partition 114 within the virtual disk 112, the data modification identification engine 104 further seeks each file system 116 within the partition 114 based on the layout of the partition 114 to locate the file system journal 118. The data modification identification engine 104 then searches through the file system journal 118 to identify data I/O operations that have been performed since the last time the data associated with the virtual machine 110 (including the file systems on the virtual disk 112 of the virtual machine 110) was backed up. If the data I/O operations result in modifications to the data in the virtual disk 112 and the corresponding storage device 120, the data modification identification engine 104 further identifies portions (e.g., storage blocks) of the storage device 120 which data content has been modified since the last backup based on the records of changed file system entries in the file system journal 118. In some embodiments, the data modification identification engine 104 also utilizes the mapping table between the virtual disk 112 and the storage device 120 to identify the portions of the storage device which data have been modified by the disk operations. For backup of the data associated with the virtual machine 112, the data modification identification engine 104 only submits the portions of the storage device 120 which data content has been modified to the data backup engine 106 without submitting data blocks and portions of the storage device 120 which content has been unchanged since the last backup.

In the example of FIG. 1, the data backup engine 106 performs a backup process of the data associated with the virtual machine 110 by copying and transmitting only portions of the storage device 120 which data content has been modified to a back storage device 122 at a separate location from the storage device 120. In some embodiments, the data backup engine 106 performs the backup process of the data associated with the virtual machine 110 either on regular basis according to a time schedule or as requested by the virtual machine 110 on demand. In some embodiments, the data backup engine 106 creates a snapshot of the data associated with the virtual machine 110 before performing the backup process, wherein the snapshot may include a virtual “copy” of the virtual disks used by the virtual machine 110.

During the backup process, the data backup engine 106 may first request and receive from the data modification identification engine 104 information on the portions of the storage device 120 which data has been modified since the last backup. Once such information has been identified based on the file system journal 118 and provided to the data backup engine 106 by the data modification identification engine 104, the data backup engine 106 will perform the backup process by issuing a backup command to the disk controller and/or another component controlling the data transmission of the storage device 120 to transfer the identified portions of the storage device 120 to the back storage device 122. In some embodiments, the data backup engine 106 submits information on the portions of the storage device 120 which data has been modified since the last backup as an additional argument to the backup command.

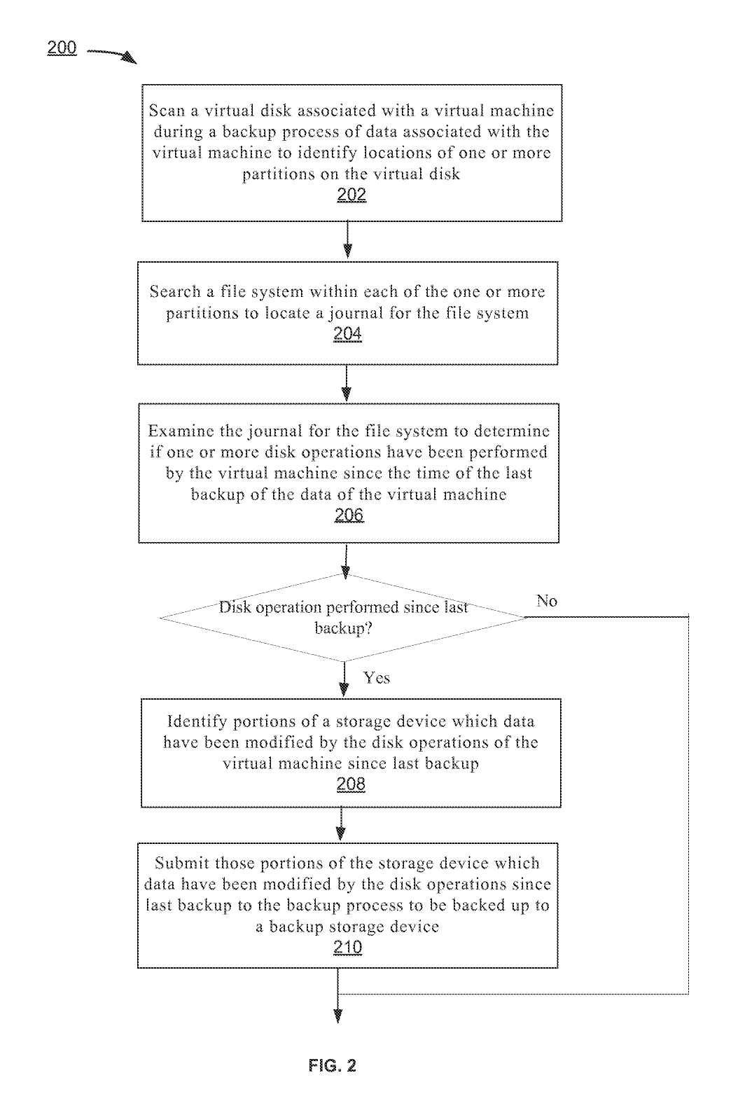

FIG. 2 depicts a flowchart of an example of a process to support backup of virtual machine data via file system journal examination. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where a virtual disk associated with a virtual machine is scanned during a backup process of data associated with the virtual machine to identify locations of one or more partitions on the virtual disk. The flowchart 200 continues to block 204, where a file system within each of the one or more partitions is searched to locate a journal for the file system. The flowchart 200 continues to block 206, where the journal for the file system is examined to determine if one or more disk operations have been performed by the virtual machine since the time of the last backup of the data of the virtual machine. If so, the flowchart 200 continues to block 208, where portions of a storage device which data have been modified by the disk operations of the virtual machine since the time of the last backup are identified. The flowchart 200 end at block 210 where only those portions of the storage device which data have been modified by the disk operations since the time of the last backup are submitted to the backup process to be backed up to a backup storage device.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a data modification identification engine running on a host, which in operation, is configured to
scan a virtual disk associated with a virtual machine during a backup process of data associated with the virtual machine to identify locations of one or more partitions on the virtual disk;
search a file system within each of the one or more partitions to locate a journal for the file system;
examine the journal for the file system to determine if one or more disk operations have been performed by the virtual machine since time of last backup of the data of the virtual machine;
identify portions of a storage device which data have been modified by the one or more disk operations of the virtual machine since time of the last backup if the one or more disk operations have been performed;
submit the portions of the storage device which data have been modified by the disk operations since the time of the last backup to the backup process;
a data backup engine running on a host, which in operation, is configured to back up the portions of the storage device which data have been modified by the disk operations since the time of the last backup to a backup storage device during the backup process.

2. The system of claim 1, wherein:
the file system is one of a New Technology File System (NTFS), a File Allocation Table (FAT), and a High Performance File System (HPFS).

3. The system of claim 1, wherein:
the journal for the file system records changes in the file system as files, directories, and other file system objects are added, deleted, and/or modified in the file system by the virtual machine.

4. The system of claim 1, wherein:
the journal for the file system includes one or more of disk I/O operations performed by the virtual machine to the file system, types of the disk operations being performed on the data, and locations of the data objects and storage blocks which data has been modified by the operations.

5. The system of claim 1, wherein:
the journal for the file system includes timestamps of the disk operations performed.

6. The system of claim 1, wherein:
the data modification identification engine is configured to access the file system journal via an Application Programming Interface (API) provided by the hypervisor.

7. The system of claim 1, wherein:
the data modification identification engine is configured to utilize a mapping table between the virtual disk and the storage device to identify the portions of the storage device which data have been modified by the disk operations.

8. The system of claim 1, wherein:
the data modification identification engine is configured to skip submitting portions of the storage device which content has been unchanged since the last backup to the backup process.

9. The system of claim 1, wherein:
the data backup engine is configured to perform the backup process of the data associated with the virtual machine either on regular basis according to a time schedule or as requested by the virtual machine on demand.

10. The system of claim 1, wherein:
the data backup engine is configured to perform the backup process by issuing a backup command to a component controlling data transmission of the storage device to transfer the identified portions of the storage device to the back storage device.

11. The system of claim 10, wherein:
the data backup engine is configured to submit information on the portions of the storage device which data has been modified since the last backup as an additional argument to the backup command.

12. A computer-implemented method, comprising:
scanning a virtual disk associated with a virtual machine during a backup process of data associated with the virtual machine to identify locations of one or more partitions on the virtual disk;
searching a file system within each of the one or more partitions to locate a journal for the file system;
examining the journal for the file system to determine if one or more disk operations have been performed by the virtual machine since time of last backup of the data of the virtual machine;
identifying portions of a storage device which data have been modified by the one or more disk operations of the virtual machine since the time of the last backup if the one or more disk operations have been performed;
submitting the portions of one or more disks which data have been modified by the disk operations since the time of the last backup to the backup process to be backed up to a backup storage device.

13. The method of claim 12, further comprising:
recording changes in the file system in the journal for the file system as files, directories, and other file system objects are added, deleted, and/or modified in the file system by the virtual machine.

14. The method of claim 12, further comprising:
accessing the file system journal via an Application Programming Interface (API) provided by the hypervisor.

15. The method of claim 12, further comprising:
utilizing a mapping table between the virtual disk and the storage device to identify the portions of the storage device which data have been modified by the disk operations.

16. The method of claim 12, further comprising:
skipping submitting portions of the storage device which content has been unchanged since the last backup to the backup process.

17. The method of claim 12, further comprising:
performing the backup process of the data associated with the virtual machine either on regular basis according to a time schedule or as requested by the virtual machine on demand.

18. The method of claim 12, further comprising:
performing the backup process by issuing a backup command to a component controlling data transmission of the storage device to transfer the identified portions of the storage device to the back storage device.

19. The method of claim 18, further comprising:
submitting information on the portions of the storage device which data has been modified since the last backup as an additional argument to the backup command.

20. A non-transitory computer readable medium having software instructions stored thereon that when executed cause a system to:
scan a virtual disk associated with a virtual machine during a backup process of data associated with the virtual machine to identify locations of one or more partitions on the virtual disk;
search a file system within each of the one or more partitions to locate a journal for the file system;
examine the journal for the file system to determine if one or more disk operations have been performed by the virtual machine since time of last backup of the data of the virtual machine;
identify portions of a storage device which data have been modified by the one or more disk operations of the virtual machine since the time of the last backup if the one or more disk operations have been performed;
submit the portions of one or more disks which data have been modified by the disk operations since the time of the last backup to the backup process to be backed up to a backup storage device.
